(19) United States
(12) Patent Application Publication
(10) Pub. No.: US 2020/0406896 A1
(43) Pub. Date: Dec. 31, 2020

(54) DRIVING ASSIST APPARATUS, DRIVING ASSIST METHOD AND PROGRAM THEREFOR

(71) Applicant: DENSO CORPORATION, Kariya-city (JP)

(72) Inventors: Keisuke SUZUKI, Kariya-city (JP); Masakazu KAGAWA, Kariya-city (JP)

(21) Appl. No.: 16/911,273

(22) Filed: Jun. 24, 2020

(30) Foreign Application Priority Data
Jun. 26, 2019 (JP) 2019-118060

(51) Int. Cl. B60W 30/18; B60W 50/14; B60W 60/00

(52) U.S. Cl. CPC B60W 30/18163; B60W 50/14; B60W 2050/008; B60W 60/0016; B60W 60/0017; B60W 30/18154

(57) ABSTRACT

A driving assist apparatus includes a subject vehicle information receiving unit receiving information from a subject vehicle that requires a lane change; a vicinity vehicle information receiving unit receiving information from a vicinity vehicle existing in the vicinity of the subject vehicle; a lane-change permission degree calculation unit calculating, based on information of the subject vehicle and information of the vicinity vehicle, a lane-change permission degree for respective travelling vehicles present in a destination lane, the lane-change permission degree being a degree of permission for the subject vehicle to perform a lane change to interrupt a space ahead of an object travelling vehicle in the destination lane; and a lane-change vehicle determination unit determining, based on the lane-change permission degree, the object travelling vehicle in front of which the subject vehicle interrupts an available space in the destination lane and notifies the subject vehicle about the object travelling vehicle.

### CROSS-REFERENCE TO RELATED APPLICATION

This application is based on and claims the benefit of priority from earlier Japanese Patent Application No. 2019-118060 filed Jun. 26, 2019, the description of which is incorporated herein by reference.

### BACKGROUND

### Technical Field

The present disclosure relates to a driving assist apparatus, a driving assist method and a program therefor.

### Description of the Related Art

Driving assist techniques have been widely developed. As a conventional technique for an autonomous driving vehicle, in the case where the autonomous driving vehicle changes the lane to interrupt a vehicle travelling on the adjacent lane, the autonomous driving vehicle and a vehicle travelling on the adjacent lane perform mutual communication.

### SUMMARY

A driving assist apparatus according to the present disclosure includes a subject vehicle information receiving unit; a vicinity vehicle information receiving unit; a lane-change permission degree calculation unit; and a lane-change vehicle determination unit.

The subject vehicle information receiving unit receives information from a subject vehicle that requires a lane change. The vicinity vehicle information receiving unit that receives information from a vicinity vehicle existing in the vicinity of the subject vehicle. The lane-change permission degree calculation unit calculates, based on information of the subject vehicle and information of the vicinity vehicle, a lane-change permission degree for respective travelling vehicles present in a destination lane. The lane-change vehicle determination unit determines, based on the lane-change permission degree, the object travelling vehicle in front of which the subject vehicle interrupts an available space in the destination lane and notifies the subject vehicle about the object travelling vehicle.

### BRIEF DESCRIPTION OF THE DRAWINGS

In the accompanying drawings:

FIG. 1 is a block diagram showing a system configuration of an autonomous driving assist system according to an embodiment of the present disclosure;

FIG. 2 is a functional block diagram showing an on-vehicle equipment according to the embodiment of the present disclosure;

FIG. 3 is a diagram explaining an overview of the embodiment of the present disclosure;

FIG. 4 is a functional block diagram of a server according to the embodiment of the present disclosure;

FIG. 5 is a diagram showing a process for a case where an intersection is close to a vehicle;

FIG. 6 is a diagram explaining a process for a case where a following vehicle is present;

FIG. 7 is a diagram showing an intervehicle distance;

FIG. 8 is graphs each showing an example of a function acquiring a lane-change permission degree;

FIG. 9 a diagram explaining a determination whether a lane change is allowed;

FIG. 10 is an image diagram when an interrupted vehicle is repeatedly determined;

FIG. 11 is a flowchart showing an example of an interrupt assist process according to the embodiment of the present disclosure; and

FIG. 12 is a flowchart showing an example of a lane change control process according to the embodiment of the present disclosure.

### DETAILED DESCRIPTION OF THE PREFERRED EMBODIMENTS

As a conventional technique for a driving assist apparatus, for example, Japanese Patent Application Laid-Open Publication Number 2018-169895 discloses a technique in which a mutual communication is performed between an autonomous driving vehicle interrupting an adjacent lane where vehicles are in a platoon travelling and a vehicle on the adjacent lane to be interrupted such that a deceleration request is sent to the vehicle on the adjacent lane, thereby producing a space for interrupting.

According to the autonomous driving assist system disclosed by the above-mentioned patent literature, a request is sent to vehicles in the interrupt destination to accelerate or decelerate, thereby producing space between the vehicles and performing a lane change operation. Thus, a vehicle is able to change lane to a lane in traffic congestion smoothly.

However, according to the technique disclosed by the above-mentioned patent literature, since the vehicle to be interrupted is required to automatically decelerate in response to the request, the vehicle cannot interrupt if the vehicle to be interrupted is not autonomous driving vehicle. Thus, since the vehicle in the interrupt destination is required to have an autonomous driving function and a driving assist function, applying the technique is more difficult as the number of manual driving vehicles increases.

Hereinafter, with reference to the drawings, embodiments of the present disclosure will be described.

Firstly, an overview of embodiments of the present disclosure will be described prior to describing detailed embodiments of the present disclosure.

### Embodiments

According to an embodiment, a case is assumed in which an autonomous driving vehicle interrupts an adjacent vehicle, and a vehicle being interrupted is a connected vehicle (regardless of autonomous driving vehicle or non-autonomous driving vehicle).

In the case where an own vehicle automatically interrupts onto a congested lane, a server computer in a control center detects vehicle information for the destination lane via a wireless communication, and applies an interrupt permission degree to respective vehicles in accordance with the detected vehicle information. The interrupt permission degree refers to a degree of permission for interruption. The server dynamically determines the travelling vehicle to be interrupted in accordance with the interrupt permission degree, and the vehicle performs a lane change to interrupt a space ahead of the travelling vehicle (i.e. front space) in the destination lane.

At this time, the respective travelling vehicles transmit information (e.g. vehicle speed, intervehicle distance) about the travelling vehicles to the server in the control sensor. Hence, when a vehicle to be interrupted is a connected vehicle, the subject vehicle is able to interrupt the vehicle to be interrupted even it is a non-autonomous driving vehicle.

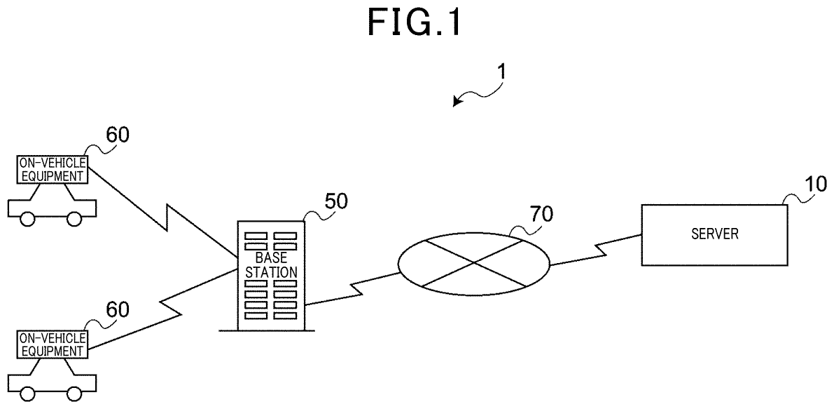

An autonomous driving assist system 1 according to an embodiment of the present disclosure will be described. As shown in FIG. 1, the autonomous driving assist system 1 is provided with a server 10 disposed in a control center, a base station 50, and a plurality of on-vehicle equipment disposed on a plurality of vehicles. The base station 50 and the server 10 are connected via a network 70 such as the internet, and the base station 50 and the on-vehicle equipment 60 are connected by wireless communication. Note that the server 10 is an example of a driving assist apparatus.

The on-vehicle equipment 60 transmits the information about the own vehicle to the server 10.

The on-vehicle equipment 60 includes CPU, RAM and ROM storing a program. The on-vehicle equipment 60 is configured as the following functional blocks.

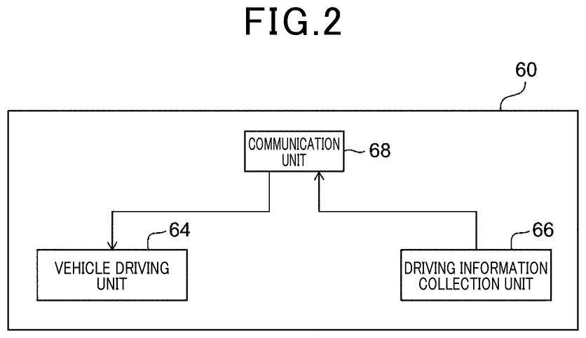

As shown in FIG. 2, the on-vehicle equipment 60 is provided with a vehicle driving unit 64, a driving information collection unit 66 and a communication unit 68.

The vehicle driving unit 64 uses existing driving means (manual or autonomous driving) to drive the vehicle.

The driving information collection unit 66 collects driving information and transmits the collected driving information to the server 10 via the communication unit 68. The driving information includes a travelling position, a vehicle speed and an acceleration of the own vehicle.

In the case where the own vehicle is an autonomous driving vehicle and the own vehicle operates in an autonomous driving mode, the vehicle driving unit 64 uses information received by the communication unit 68 which is transmitted from the server 10, to drive the vehicle. In the case where the own vehicle is in an autonomous driving mode and requires a lane change to a congested lane, the communication unit 68 transmits an interrupt assist request to the server 10.

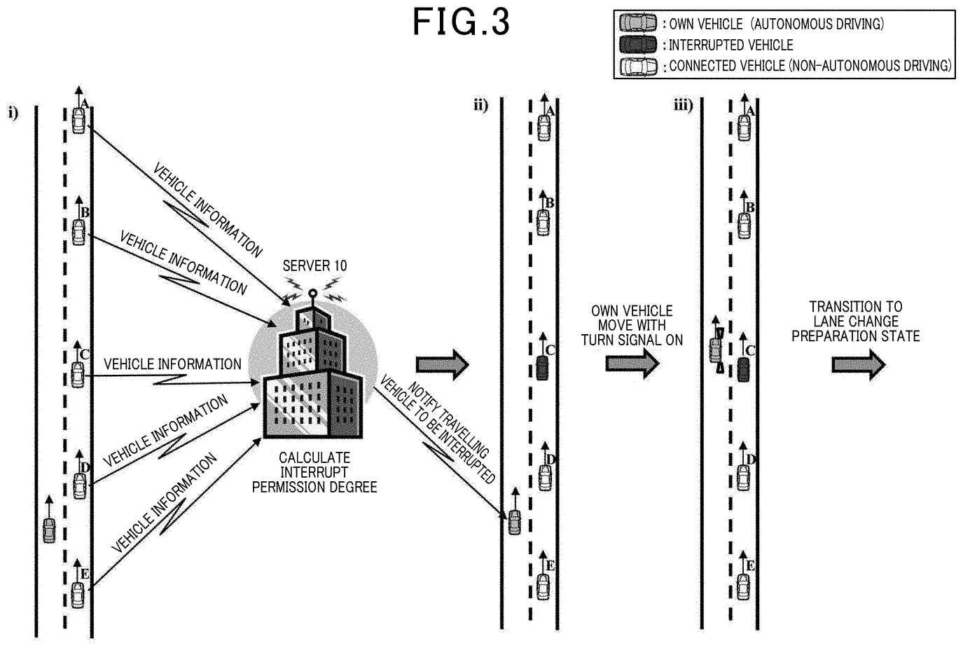

The server 10 calculates the interrupt permission degree for respective travelling vehicles in the destination lane to determine an object travelling vehicle to be interrupted (hereinafter also referred to as interrupted vehicle), and transmits the information about the object travelling vehicle. The own vehicle receives the transmitted information at the communication unit 68 (FIG. 3).

When the vehicle driving unit 64 receives the information about the interrupted vehicle, the driving unit 64 turns a turn signal ON and moves the own vehicle to be in a position corresponding to a space ahead of the interrupted vehicle in the own lane, while decelerating the own vehicle.

When the own vehicle reaches the position in a lane where the own vehicle travels (i.e. own lane), corresponding to the space ahead of the interrupted vehicle, the vehicle driving unit 64 changes the state to be a lane-change preparation state, and moves the own vehicle into the space ahead of the interrupted vehicle, thereby completing a lane change operation.

The communication unit 68 uses an existing means (e.g. mobile networks, WiFi communication) to perform the communication with the base station 50.

The server 10 includes CPU, RAM and ROM storing programs for executing various processes which will be described later. The server 10 is configured as the following functional blocks.

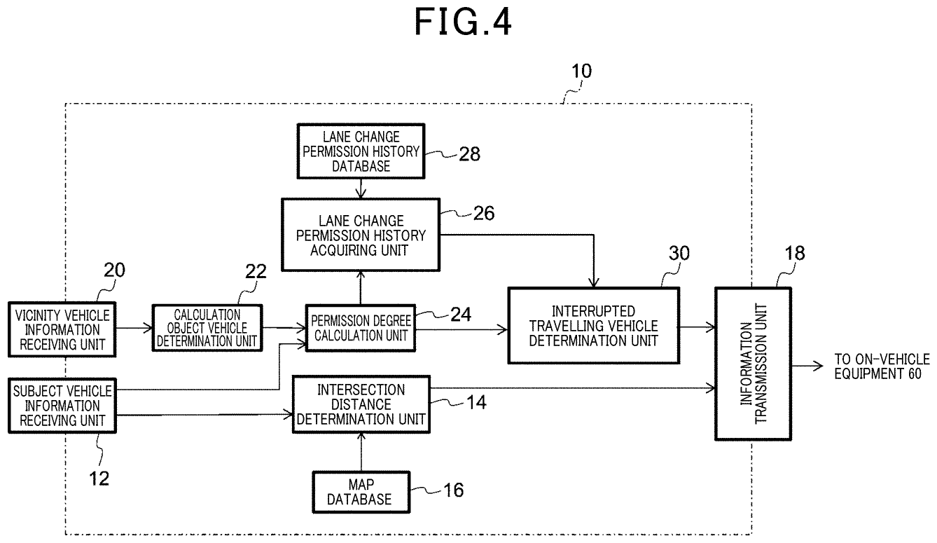

As shown in FIG. 4, the server 10 is provided with a subject vehicle information receiving unit 12, an intersection distance determination unit 14, map data base 16 and an information transmission unit 18.

The subject vehicle information receiving unit 12 receives an interrupt assist request via the on-vehicle equipment 60, and receives driving information of the subject vehicle including the on-vehicle equipment mounted thereon as needed.

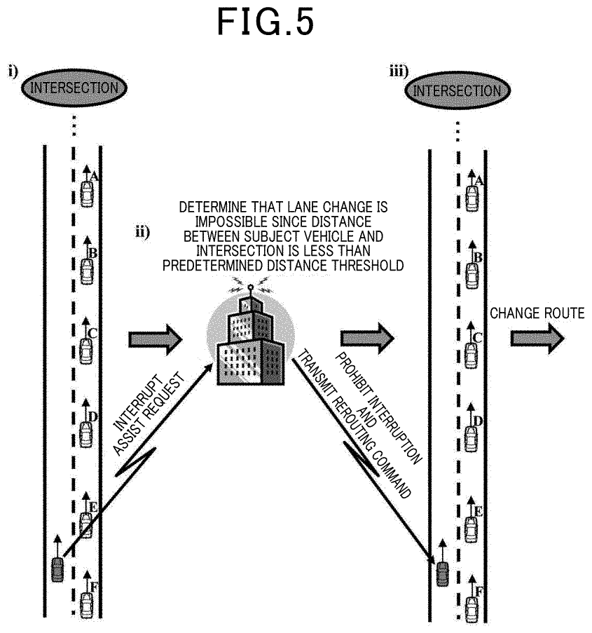

As shown in FIG. 5, the intersection distance determination unit 14 transmits, based on intersection location information obtained from the map data stored in the map data base 16 and the location of the subject vehicle, a message indicating a prohibition of a lane change and a command conducting a travelling route without using the destination lane to the subject vehicle via the information transmission unit 18, when the distance between the subject vehicle and the intersection is less than a predetermined threshold.

Also, the server 10 includes a vicinity vehicle information receiving unit 20, a calculation object vehicle determination unit 22, a permission degree calculation unit 24, a lane-change permission history acquiring unit 26, a lane-change permission history database 28 and an interrupted vehicle determination unit 30.

The vicinity vehicle information receiving unit 20 receives, from the on-vehicle equipment 60 of a vicinity vehicle which is a vehicle travelling in the vicinity of the subject vehicle that transmits an interrupt assist request, driving information of the vicinity vehicle provided with the on-vehicle equipment 60 as needed.

The calculation object vehicle determination unit 22 determines, based on the travelling speed and the acceleration of the subject vehicle and the travelling speed and the acceleration of the vicinity vehicle in the destination lane, a travelling vehicle as a calculation object among travelling vehicles in the destination lane. For example, the calculation object vehicle determination unit 22 determines a predetermined range (front area and rear area of the subject vehicle) specified in accordance with a combination of the travelling speed and the acceleration of the subject vehicle and the average travelling speed and the average acceleration factor of the vicinity vehicles in the destination lane, to be a range of the travelling vehicles as the calculation objects.

Also, in the case where the following vehicle is present, the calculation object vehicle determination unit 22 further restricts travelling vehicles as calculation objects based on the position and the travelling speed of the following vehicle which will be described as follows.

Firstly, when a following vehicle is present, a travelling speed limit after deceleration for the interruption is determined to be faster by a predetermined speed than the average travelling speed of the vicinity vehicles in the destination lane. However, in the case where the travelling speed of the following vehicle is lower than the travelling speed limit (i.e. travelling speed faster by a predetermined speed than the average travelling speed of the vicinity vehicles in the destination lane), the travelling speed limit after deceleration for the interruption is determined to be the travelling speed of the following vehicle.

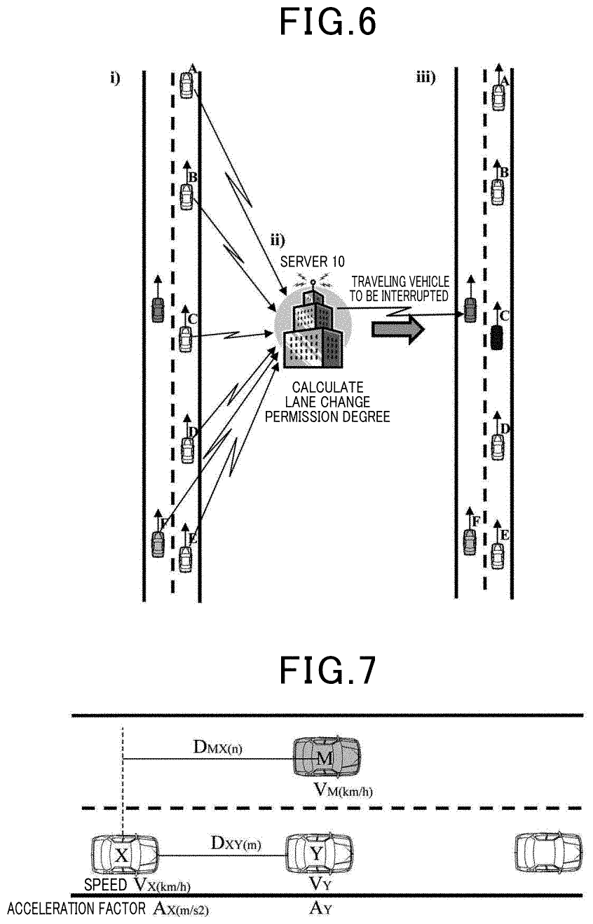

Thereafter, vicinity vehicles in the destination lane which are travelling behind the subject vehicle at a time when the travelling speed of the subject vehicle reaches the travelling speed limit by decelerating at a predetermined deceleration factor, are not determined as calculation objects. For example, as shown in FIG. 6, when the following vehicle F is present, the travelling speed limit after deceleration for the interruption is determined based on the travelling speed of the following vehicle F, and the vicinity vehicles in the destination lane travelling behind the subject vehicle at a time when the travelling speed of the subject vehicle reaches the travelling speed limit by decelerating at a predetermined deceleration factor.

The permission degree calculation unit 24 calculates, based on the driving information of the subject vehicle and each of the vicinity vehicles, a lane-change permission degree for each travelling vehicle in the destination lane as a calculation object. The lane-change permission degree refers to a degree of permission for the subject vehicle to perform a lane change to a space ahead of the travelling vehicle.

Specifically, the system acquires, based on the driving information of the subject vehicle and the vicinity vehicles, the distance between the subject vehicle and the travelling vehicle as a calculation object at a time when the travelling speed of the subject vehicle reaches the average travelling speed of the vicinity vehicles in the destination lane by decelerating at a predetermined deceleration factor. As shown in FIG. 7, The distance between the subject vehicle and the travelling vehicle as the calculation object in the destination lane refers to a distance DMX between the subject vehicle M and the travelling vehicle X as the calculation object in the destination lane in the front-back direction.

Further, the system acquires, based on the driving information of the subject vehicle and the vicinity vehicles, the intervehicle distance between the travelling vehicle of the calculation object and the preceding vehicle of the travelling vehicle of the calculation object, and an increase degree or a decrease degree of the intervehicle distance. For example, as shown in FIG. 7, the system acquires the intervehicle distance D_{XY} between the travelling vehicle X of the calculation object and the preceding vehicle Y, and an amount of increase or an amount of decrease of the intervehicle distance D_{XY} per unit time. Note that in the case where the location of the preceding vehicle cannot be detected, a small fixed value is determined as the intervehicle distance.

Thereafter, the permission degree calculation unit 24 calculates the lane-change permission degree by applying different weights to the respective parameters, at a time when the subject vehicle decelerates at a predetermined deceleration factor and the travelling speed thereof reaches the average travelling speed of the vicinity vehicles in the destination lane, and summing the weighted respective parameters. The respective parameters are the distance between the subject vehicle and the travelling vehicle as a calculation object; the intervehicle distance between the travelling vehicle of the calculation object and the preceding vehicle of the travelling vehicle of the calculation object, at a time when the subject vehicle decelerates at a predetermined deceleration factor and the travelling speed thereof reaches the average travelling speed of the vicinity vehicles in the destination lane; and the increase degree or the decrease degree of the intervehicle distance.

The weighting is applied such that the shorter the distance between the subject vehicle and the travelling vehicle when the subject vehicle decelerates and reaches the average speed of the vicinity vehicles, the higher the lane-change permission degree is, the longer the intervehicle distance between the travelling vehicle of the calculation object and the preceding vehicle, the higher the lane-change permission degree is, the larger the increase degree of the intervehicle distance, the higher the lane-change permission degree is, and the larger the decrease degree of the intervehicle distance, the lower the lane-change permission degree is.

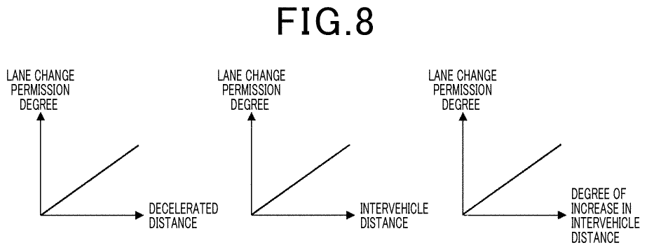

In the above-described control, a case is exemplified in which weight-summing is performed to calculate the lane-change permission degree. However, it is not limited to this technique. Alternatively, the lane-change permission degree may be calculated with a function using relationships shown in FIG. 8 including a relationship between the intervehicle distance of the subject vehicle after the deceleration and the lane-change permission degree, a relationship between the intervehicle distance between the subject vehicle and the preceding vehicle and the lane-change permission degree, and a relationship between the increase degree of the intervehicle distance between the subject vehicle and the preceding vehicle and the lane-change permission degree.

The lane-change permission history acquiring unit 26 acquires, when the maximum lane-change permission degree calculated by the permission degree calculation unit 24 is less than a threshold, a lane-change permission history for respective travelling vehicles of the calculation objects and calculates the lane-change permission degree taking the lane-change permission history into consideration. The lane-change permission history is, for example, the number of permissions of the lane change in the front space.

Specifically, the lane-change permission history acquiring unit 26 calculates the lane-change permission degree by applying different weights to the respective parameters, at a time when the subject vehicle decelerates at a predetermined deceleration factor and the travelling speed thereof reaches the average travelling speed of the vicinity vehicles in the destination lane, and summing the weighted respective parameters. The respective parameters are the distance between the subject vehicle and the travelling vehicle as a calculation object; the intervehicle distance between the travelling vehicle of the calculation object and the preceding vehicle of the travelling vehicle of the calculation object; the increase degree or the decrease degree of the intervehicle distance; and the lane-change permission history of the travelling vehicle as the calculation object. The weighting is performed such that the larger the number of permissions of the lane change in the front space, the higher the permission degree is.

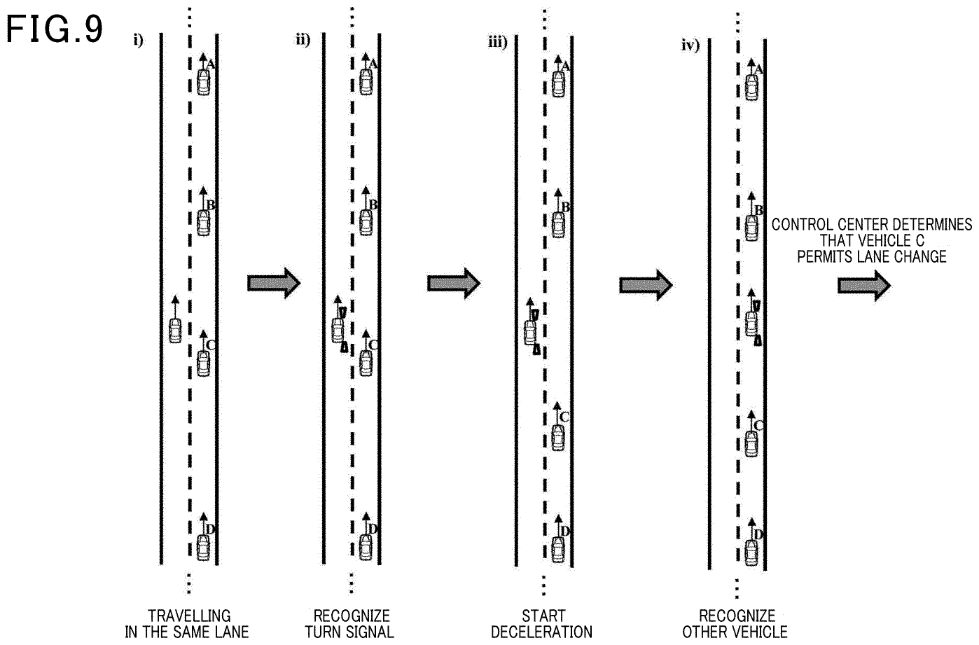

The information on whether the lane change is permitted can be collected in the following manner. For example, as shown in FIG. 9, in accordance with the driving information collected from the travelling vehicle C, in the case where the travelling vehicle C is travelling on the lane where a preceding vehicle B is travelling, detecting a turn signal of a travelling vehicle on the adjacent lane, the travelling vehicle C starts to decelerate. Thereafter, when the preceding vehicle is changed to be the travelling vehicle B, it is determined that the lane change is permitted.

Further, the lane-change permission degree may be calculated considering a violation rate of traffic regulation or a level of driver's license without the lane-change permission history.

The interrupted vehicle determination unit 30 determines a lane change to be performed in the front space of the travelling vehicle having the maximum lane-change permission degree among the lane-change permission degrees calculated by the permission degree calculation unit 24, and notifies the on-vehicle equipment 60 in the subject vehicle about the travelling vehicle having the maximum lane-change permission degree as an interrupted vehicle, via the information transmission unit 18.

The interrupted vehicle determination unit 30 determines, when the maximum lane-change permission degree calculated by the permission degree calculation unit 24 is less than a threshold, a lane change to be performed in front of the travelling vehicle having the maximum lane-change permission degree among the lane-change permission degrees calculated by the lane-change permission history acquiring unit 26, and notifies the on-vehicle equipment 60 in the subject vehicle about the travelling vehicle having the maximum lane-change permission degree as an interrupted vehicle, via the information transmission unit 18.

The system repeatedly performs respective processes of the subject vehicle information receiving unit 12, the vicinity vehicle information receiving unit 20, the permission degree calculation unit 24, the lane-change permission history acquiring unit 26 and the interrupted vehicle determination unit 30, while the subject vehicle moves towards a location corresponding to the space ahead of the determined subject vehicle.

At this time, when the travelling vehicle to be interrupted is present which has been notified in the previous cycle, the system prioritizes this traveling vehicle to be determined as a travelling vehicle to be interrupted. Specifically, the interrupted vehicle determination unit 30 weights the travelling vehicle to be interrupted such that the lane-change permission degree is larger than those of other travelling vehicle, and allows the subject vehicle to perform a lane change in a space ahead of the travelling vehicle having the maximum lane-change permission degree. Also, the interrupted vehicle determination unit 30 may weight a travelling vehicle positioned closely to the travelling vehicle to be interrupted which has been notified in the previous cycle such that the lane-change permission degree thereof are slightly larger than those of other travelling vehicles. Thus, the travelling vehicle positioned closely to the travelling vehicle to be interrupted can readily be selected next to the travelling vehicle to be interrupted which has been notified in the previous cycle.

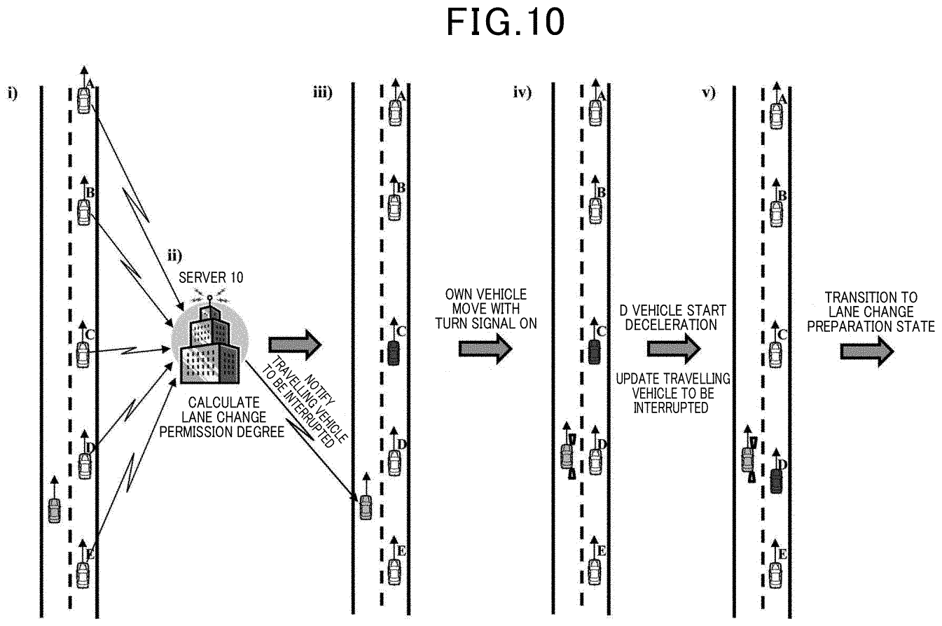

Thus, the system repeatedly performs a process to determine the travelling vehicle to be interrupted at a constant period while the subject vehicle moves towards a location corresponding to the space ahead of the determined subject vehicle. As shown in FIG. 10, according to a determination in which a travelling vehicle to be firstly interrupted is determined, even if the vehicle C is determined as a travelling vehicle to be interrupted, when the travelling vehicle D notices the turn signal being ON in the subject vehicle thus starts to decelerate, the lane-change permission degree of the travelling vehicle D increases. Hence, a determination for a travelling vehicle to be interrupted is repeatedly performed, whereby the travelling vehicle D can be determined as a travelling vehicle to be interrupted, and the determination can be notified to the subject vehicle.

Next, effects and advantages of an autonomous driving assist system 1 according to the present embodiment will be described. An on-vehicle equipment 60 of the respective travelling vehicles transmits the driving information including a location, a travelling speed, and an acceleration factor to the server 10 via the communication unit 68 as needed.

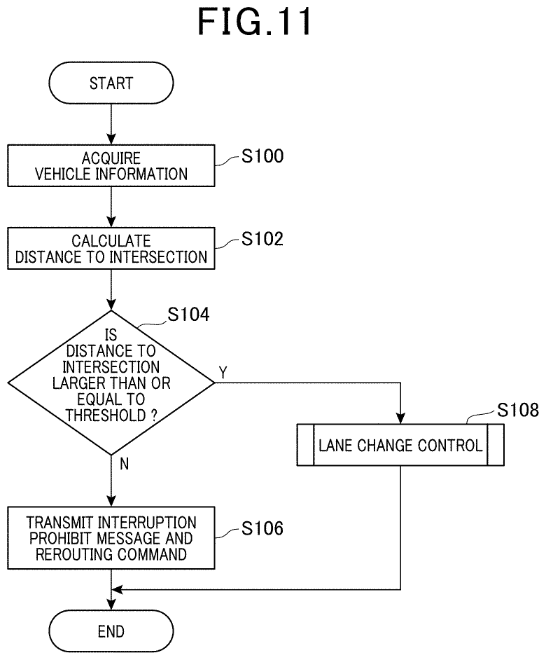

In the case where the subject vehicle is driven in an autonomous driving mode and the system requires to move the subject vehicle to a congested lane, an interrupt assist request is transmitted to the server 10 from the on-vehicle equipment 60 of the subject vehicle. Thereafter, an interrupt assist process shown in FIG. 11 is executed in the server 10.

The interrupt assist process shown in FIG. 11 will be described.

First, at step S100, subject vehicle information receiving unit 12 acquires driving in formation of the subject vehicle including the on-vehicle equipment 60 which has transmitted the interrupt assist request.

At step S102, the intersection distance determination unit 14 calculates, based on intersection location information obtained from the map data stored in the map data base 16 and the location of the subject vehicle, the distance between the subject vehicle and the intersection.

At step S104, the intersection distance determination unit 14 determines whether the distance between the subject vehicle and the intersection calculated at the above-described step S102 is larger than or equal to a predetermined threshold. When the distance between the subject vehicle and the intersection is less than the predetermined threshold, the process transmits, at step S106, a message indicating a prohibition of a lane change and a command conducting a travelling route without using the destination lane via the information transmission unit 18 to the on-vehicle equipment 60 of the subject vehicle 60, and terminates the interrupt assist process.

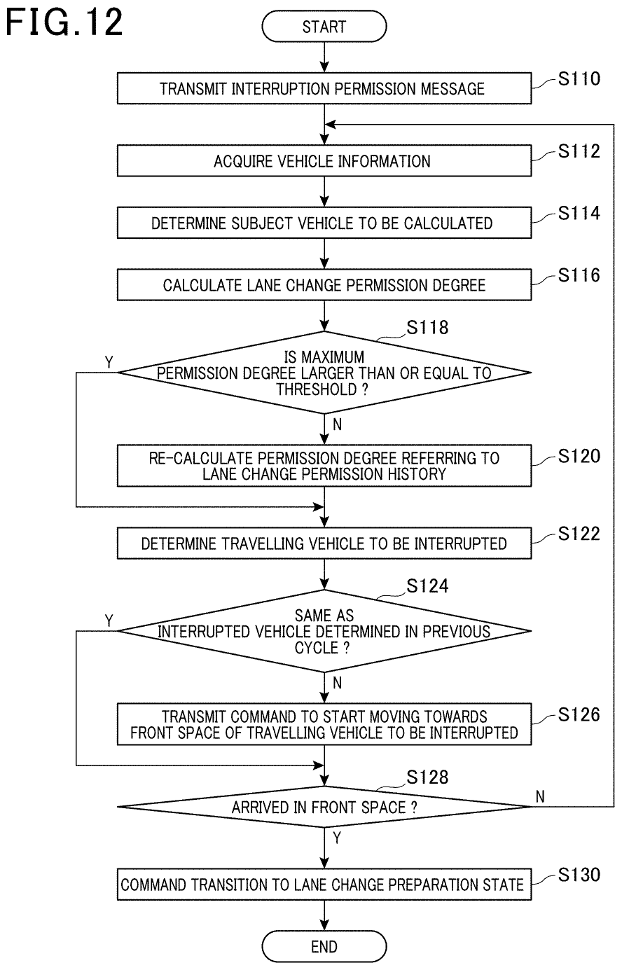

On the other hand, when the distance between the subject vehicle and the intersection is larger than or equal to the predetermined threshold, the process executes, at step S108, a lane change control process shown in FIG. 12 and terminates the interrupt assist process.

Next, the lane change control process shown in FIG. 12 will be described.

At step S110, the process transmits an interrupt enabling message to the on-vehicle equipment 60 of the subject vehicle via the information transmission unit 18.

At step S112, the subject vehicle information receiving unit 12 to acquires the driving information of the subject vehicle including the on-vehicle equipment 60 mounted thereon which has transmitted the interrupt assist request, and the vicinity vehicle information receiving unit 20 acquires the driving information of the travelling vehicles in the vicinity of the subject vehicle.

At step S114, the calculation object vehicle determination unit 22 determines, based on the travelling speed and the acceleration factor of the subject vehicle and the travelling speed and an acceleration factor of each vicinity vehicle in the destination lane, a travelling vehicle as a calculation object.

At step S116, the process calculates, based on the driving information of the subject vehicle and the driving information of the vicinity vehicles, the lane-change permission degree for respective travelling vehicles in the destination lane as calculation objects.

At step S118, the interrupted vehicle determination unit 30 determines whether the maximum lane-change permission degree calculated by the permission degree calculation unit 24 is larger than or equal to the threshold. When the maximum lane-change permission degree is larger than or equal to the threshold, the process proceeds to step S122, and the process proceeds to step S120 when the maximum lane-change permission degree is less than the threshold.

At step S120, the interrupted vehicle determination unit 30 acquires a lane-change permission history for respective travelling vehicles as calculation objects from the lane-change permission history database 28, and calculates the lane-change permission degree taking the lane change permission history into further consideration.

At step S122, the interrupted vehicle determination unit 30 determines a lane change to be performed in the front space of the travelling vehicle having the maximum lane-change permission degree among the lane-change permission degrees calculated by the above-described step S116 or step S120, and determines the travelling vehicle having the maximum lane change permission degree as a travelling vehicle to be interrupted. Then, the process notifies the on-vehicle equipment 60 in the subject vehicle about the travelling vehicle determined as an interrupted vehicle, via the information transmission unit 18.

At step S124, the interrupted vehicle determination unit 30 determines whether the travelling vehicle determined as an interrupted vehicle at step S122 is the same as the interrupted vehicle determined in the previous cycle. When determined that the travelling vehicle determined as an interrupted vehicle at step S122 is the same as the interrupted vehicle determined in the previous cycle, the process proceeds to step S128. On the other hand, when the travelling vehicle determined as an interrupted vehicle is not the same as the interrupted vehicle determined in the previous cycle, or a travelling vehicle is determined as an interrupted vehicle for a first time, the process proceeds to step S126.

At step S126, the interrupted vehicle determination unit 30 transmits a command that commands the subject vehicle to start move to a location corresponding to the front space of the interrupted vehicle (a location in the own lane where the subject vehicle travels, which is the same as a location of the front space of the interrupted vehicle in the adjacent lane, with respect to the front-back direction) to the on-vehicle equipment 60 of the subject vehicle 60 via the information transmission unit 18.

At step S128, the process determines whether the subject vehicle reaches the location corresponding to the front space of the interrupted vehicle. When determined that the subject vehicle reaches the location corresponding to the front space of the interrupted vehicle, the process proceeds to step S130. When determined that the subject vehicle does not reach the location corresponding to the front space of the interrupted vehicle, the process returns to step S112 and repeatedly executes the above-described steps S112 to S130.

At step S130, the process transmits a state change command for changing the state to be a lane-change preparation state to the on-vehicle equipment 60 of the subject vehicle and terminates the lane change control process.

As described, the server of the autonomous driving assist system according to the present embodiment is configured to calculate the lane change permission degree for respective travelling vehicles in the destination lane based on the driving information transmitted from the subject vehicle and the vicinity vehicles, thereby determining the travelling vehicle to be interrupted. Thus, even in the case where the travelling vehicle in the destination lane is not an autonomous driving vehicle, the subject vehicle is able to move to a congested lane smoothly.

Moreover, a lane-change permission history is used to calculate the lane-change permission degree. Hence, even in a case where the interrupted vehicle is unable to be determined only using the physical information such as a travelling speed or acceleration factor, the interrupted vehicle can be appropriately determined.

In the case where the distance up to the intersection is short, the system determines that the lane change is difficult to perform. Accordingly, the system is able to command rerouting of the subject vehicle early.

Further, the system repeatedly performs a determination of the vehicle to be interrupted at predetermine periods, whereby the interrupted vehicle can be dynamically changed in accordance with a relationship between the subject vehicle and the vicinity vehicles.

Also, in the case where the following vehicle is present, vicinity vehicles as calculation objects can be restricted considering a relationship between the subject vehicle and the following vehicle.

(Modification)

According to the above-described embodiments, a case is exemplified in which on-vehicle equipment of respective vehicles transmit driving information of the own vehicle. However, it is not limited thereto. For example, on-vehicle equipment of the subject vehicle requiring a lane change may collect driving information of vicinity vehicles and transmit the collected driving information to the server. Further, a sensor provided in a roadside may detect driving information of the respective vehicles and transmit the detected driving information to the server.

According to the above-described embodiments, a case is exemplified in which the subject vehicle requiring a lane change is an autonomous driving vehicle. However, it is not limited thereto. For example, the subject vehicle requiring a lane change may be a vehicle other than the autonomous driving vehicle.

Moreover, according to the above described embodiments, the server is provided in the control center. However, it is not limited thereto. The server may be provided in the roadside, or any one of on-vehicle equipment may have the same function as that of the server.

In the above-described embodiments, CPU loads a software (i.e. program) to execute various processes. However, various processors other than CPU may execute the various processes. In this case, the processor may be configured as a programmable Logic Device (i.e. PLD) in which a circuit configuration can be changed after being manufactured, such as field programmable gate array (i.e. FPGA) or a dedicated electrical circuit as a processor having a circuit configuration designed for performing a specific process such as application specific integrated circuit (i.e. ASIC). Further, the various processes may be executed by one among these processors or the same or different types of two or more combinations of processors (e.g. a plurality of FPGAs or a combination of CPU and FPGA). Specifically, the hardware structure of these various processor is an electrical circuit in which circuit elements such as semiconductor devices are combined.

Further, according to the above-described embodiments, the program is stored (installed) in the ROM in advance. However, it is not limited thereto. The program may be provided as a non-transitory tangible storage medium such as a CD-ROM (compact disk read only memory), DVD-ROM (digital versatile disk only memory), or USB (universal serial bus) memory device. Alternatively, the program may be downloaded from external equipment via a network.

### CONCLUSION

The present disclosure provides a driving assist apparatus capable of smoothly performing a lane change to a congested traffic lane even in a case where the travelling vehicle in the destination lane is not an autonomous driving vehicle.

A driving assist apparatus according to the present disclosure includes: a subject vehicle information receiving unit that receives information from a subject vehicle that requires a lane change; a vicinity vehicle information receiving unit that receives information from a vicinity vehicle existing in the vicinity of the subject vehicle; a lane-change permission degree calculation unit that calculates, based on information of the subject vehicle and information of the vicinity vehicle, a lane-change permission degree for respective travelling vehicles present in a destination lane, the lane-change permission degree being a degree of permission for the subject vehicle to perform a lane change to interrupt a space ahead of an object travelling vehicle in the destination lane; and a lane-change vehicle determination unit that determines, based on the lane-change permission degree, the object travelling vehicle in front of which the subject vehicle interrupts an available space in the destination lane and notifies the subject vehicle about the object travelling vehicle.

A method for performing a driving assist according to the present disclosure includes steps of: receiving information from a subject vehicle that requires a lane change; receiving information from a vicinity vehicle existing in the vicinity of the subject vehicle; calculating, based on information of the subject vehicle and information of the vicinity vehicle, a lane-change permission degree for respective travelling vehicles present in a destination lane, the lane-change permission degree being a degree of permission for the subject vehicle to perform a lane change to interrupt a space ahead of an object travelling vehicle in the destination lane; and determining, based on the lane-change permission degree, the object travelling vehicle in front of which the subject vehicle interrupts a space ahead thereof in the destination lane and notifying the subject vehicle about the object travelling vehicle.

A program according to the present disclosure is a program having a computer execute processes includes: receiving process for receiving information from a subject vehicle that requires a lane change; receiving process for receiving information from a vicinity vehicle existing in the vicinity of the subject vehicle; calculating process for calculating, based on information of the subject vehicle and information of the vicinity vehicle, a lane-change permission degree for respective travelling vehicles present in a destination lane, the lane-change permission degree being a degree of permission for the subject vehicle to perform a lane change to interrupt a space ahead of an object travelling vehicle in the destination lane; and determining process for determining, based on the lane-change permission degree, the object travelling vehicle in front of which the subject vehicle interrupts a space ahead thereof in the destination lane and notifying the subject vehicle about the object travelling vehicle.

According to the driving assist apparatus, the method and the program thereof are capable of performing a lane change to a congested traffic lane even in a case where the travelling vehicle in the destination lane is not an autonomous driving vehicle.

What is claimed is:

1. A driving assist apparatus comprising:
a subject vehicle information receiving unit that receives information from a subject vehicle that requires a lane change;
a vicinity vehicle information receiving unit that receives information from a vicinity vehicle existing in the vicinity of the subject vehicle;
a lane-change permission degree calculation unit that calculates, based on information of the subject vehicle and information of the vicinity vehicle, a lane-change permission degree for respective travelling vehicles present in a destination lane, the lane-change permission degree being a degree of permission for the subject vehicle to perform a lane change to interrupt a space ahead of an object travelling vehicle in the destination lane; and
a lane-change vehicle determination unit that determines, based on the lane-change permission degree, the object travelling vehicle in front of which the subject vehicle interrupts an available space in the destination lane and notifies the subject vehicle about the object travelling vehicle.

2. The driving assist apparatus according to claim 1, wherein
the lane-change vehicle determination unit is configured to determine, when no travelling vehicle having the lane-change permission degree larger than or equal to a predetermined threshold is present, the object travelling vehicle in front of which the subject vehicle interrupts an available space in the destination lane, based on the lane-change permission degree for respective travelling vehicles which is further calculated using a lane-change permission history of the respective traveling vehicle.

3. The driving assist apparatus according to claim 1 further comprising an intersection distance determination unit that transmits a message indicating a prohibition of a lane change and a command conducting a travelling route without using the destination lane to the subject vehicle.

4. The driving assist apparatus according to claim 1,
wherein the driving assist apparatus repeatedly performs, at a constant period,
a receiving process of the subject vehicle information receiving unit,
a receiving process of the vicinity vehicle information receiving unit,
a calculation process of the lane-change permission degree calculation unit and
a determination process of the lane-change vehicle determination unit,
while the subject vehicle moves towards a location corresponding to the space ahead of the object travelling vehicle determined by the lane-change vehicle determination unit.

5. The driving assist apparatus according to claim 1, wherein
the driving assist apparatus restricts, when a following vehicle that follows the subject vehicle is present, travelling vehicles as calculation objects for calculating the lane-change permission degree, based on a position and a travelling speed of the following vehicle.

6. The driving assist apparatus according to claim 1, wherein
the lane-change permission degree calculation unit is configured to calculate the lane-change permission degree for the respective travelling vehicles, based on a distance between the subject vehicle and each travelling vehicle, an intervehicle distance between each travelling vehicle and a preceding vehicle of the each travelling vehicle, at a time when the subject vehicle decelerates at a predetermined deceleration factor and the travelling speed thereof reaches an average travelling speed of the vicinity vehicles in the destination lane, and an increase degree or a decrease degree of the intervehicle distance.

7. A method for performing a driving assist comprising steps of:
receiving information from a subject vehicle that requires a lane change;
receiving information from a vicinity vehicle existing in the vicinity of the subject vehicle;
calculating, based on information of the subject vehicle and information of the vicinity vehicle, a lane-change permission degree for respective travelling vehicles present in a destination lane, the lane-change permission degree being a degree of permission for the subject vehicle to perform a lane change to interrupt an available space ahead of an object travelling vehicle in the destination lane; and
determining, based on the lane-change permission degree, the object travelling vehicle in front of which the subject vehicle interrupts an available space in the destination lane and notifying the subject vehicle about the object travelling vehicle.

8. A program stored in a non-transitory tangible computer-readable recording media, having a computer execute processes comprising:
receiving process for receiving information from a subject vehicle that requires a lane change;
receiving process for receiving information from a vicinity vehicle existing in the vicinity of the subject vehicle;
calculating process for calculating, based on information of the subject vehicle and information of the vicinity vehicle, a lane-change permission degree for respective travelling vehicles present in a destination lane, the lane-change permission degree being a degree of permission for the subject vehicle to perform a lane change to interrupt an available space ahead of an object travelling vehicle in the destination lane; and
determining process for determining, based on the lane-change permission degree, the object travelling vehicle in front of which the subject vehicle interrupts an available space in the destination lane and notifying the subject vehicle about the object travelling vehicle.
